(19) United States
(12) Patent Application Publication
(10) Pub. No.: US 2007/0294318 A1
(43) Pub. Date: Dec. 20, 2007

(54) Method, System, and Apparatus for Auditing, Tracking, or Inspection of Data, Objects, or Their Corresponding Modifications

(76) Inventors: Amrinder S. Arora, Centreville, VA (US); Rajender Arand, Vienna, VA (US)

Correspondence Address: MAXVALUEIP CONSULTING, 11204 ALBERMYRTLE ROAD, POTOMAC, MD, 20854, US

(21) Appl. No.: 11/765,461

(22) Filed: Jun. 20, 2007

Related U.S. Application Data
(60) Provisional application No. 60/814,907, filed on Jun. 20, 2006.

(51) Int. Cl. G06F 17/30

(52) U.S. Cl. 707/202

(57) ABSTRACT

A method and system for tracking changes to business data objects are presented. The system tracks changes to business data object of an underlying software system. It records data after each change to the business data object, and allows the user to review past versions, and compare different versions. The system is able to pinpoint exactly what change was made to a business data object. It is a self-contained system that can understand complex, hierarchical business data, spanning an unlimited number of tables. It does not add additional complexities to business logic, and does not alter the production database.

### RELATED APPLICATION

This application relates to (is based on) a co-pending provisional application, with the same assignee and inventors, filed Jun. 20, 2006, at the US PTO (Ser. No. 60/814,907). All of the teachings of the provisional application are incorporated herein by reference.

### BACKGROUND

The system relates to electronic data management, wherein a software system is used to record data transactions into an electronic data repository, such as a relational database.

In today's world, computers are in each and every aspect of our lives. Most of this is a result of the computer's ability to rapidly process billions and billions of transactions. When a customer buys a book, the merchant's (or store's) computer records name of the book, the author, the price, and even who you are, capturing every possible aspect of the transaction in the process.

Without computers, the stock market, manufacturing, or in fact, many (almost all) essential aspects of retail and commercial trade would not be feasible. Wherever there are too many transactions, we invariably rely on computers. The modern day business environment would not have existed, if it were not for the computers to manage billions and billions of daily transactions in stocks, commodities, inventory, and other supplements of economy.

Computers record transactions, store them, and eventually are capable of producing consolidated records for people who need to interpret them. This analytical and interpretive capability converts mundane transactions into vital business information. Computers filter and flag items that match certain criteria, which enables people to interpret the information. Business people continually review the flow of transactional information to monitor financial status and analyze business trends.

Nowadays every business needs to manage transactions because it is generally accepted that companies may have to reveal certain financial and management information to the government and public users for compliance purposes, and because transaction management is an indispensable tool in business decision-making process. The development of information technologies has made this easy for those who manage them. Every transaction must be recognized, classified, and stored.

Manual transaction management implies that human resources perform the whole cycle manually on a periodic basis: They capture the transaction, journalize them, and perform other routines. Of course, it takes much more time, resources, and effort in large organizations. Computerized transaction handling implies that the only thing that employees do is to record the transactions into the computer, and the computer processes the other steps of the transaction automatically, or by a request.

With the adoption of modern-day information technology, almost every transaction is maintained using computers. Take a scenario/ an example: A shipment transaction is created, and it is entered in the automated system. This typically includes the destination of the goods, amount, weight, the receiver's name, and so on. During the course of the shipment, the customer is offered a discount on bulk shipment. In the IT system of the shipment firm, this information is updated in the database by simply replacing the old amount with the discounted amount. This information is also auto-updated at the receiving end of the shipment firm. The goods are delivered at the destination. The automation of the transaction made it possible to update the data in real-time, so that there are no disputes. However, a problem may arise when the management notices that a particular shipment is made on a lower (discounted) rate. To find out the reason behind this, they check the database. However, they do not find who made the changes, when the changes were made, and why the changes were done. The discounted rate, although correct, may create a suspicion that this may be a case of system intrusion, where the intruder has deliberately modified the rates of a particular shipment. Being a paperless transaction, there is no way to find the actual reasons of such instances.

If the above instance happens in a paper based (manual) system, there would have been a paper trace of why, who, and when the event happened. However, with the modern day computerized system, this is not possible. There are no paper trails to a change made to any transaction. In such systems, the transactions are simply edited and saved, leaving no traces of old values for the data objects.

Thus, there is a well-understood need for an audit tracking solution that tracks changes to objects form a business's perspective.

Typical past approaches to this problem have used customized solution for each target system, or have proposed versioning of records in the production database, flagging the older records using some status columns, using pseudo primary keys, or using cumbersome data tables to provide field by field changes. These approaches suffer significant disadvantages, including high cost, technical complexity and poor adaptability, and tightly coupled change tracking with core business logic. Due to the challenges of tracking changes to business data, in many cases, this functionality is not enabled, even if it has clear business benefits.

Some of the prior art are:

C. T. Davies, Jr., “Recovery semantics for a DB/DC system”, Proceedings, ACM '73, 136-141 (1973).

L. A. Bjork, Jr., “Generalized audit trail requirements and concepts for database applications”, IBM Systems Journal, No 3, 229-244 (1975).

James V. Hansen, Ned C. Hill, “Control and Audit of Electronic Data Interchange”, MIS Quarterly, 403-413, Vol. 13, No. 4 (December 1989).

Dimitris Karagiannis, Stefan Junginger, Robert Strobl, “Introduction to Business Process Management Systems Concepts”, University of Vienna, 81-106, 1996.

Brett McLaughlin, “Java & XML: Solutions to Real-World Problems”, O'Reilly Media, 2001.

Robert Filman, Tzilla Elrad, Siobhan Clarke, Mehmet Aksit, “Aspect Oriented Software Development”, Addison-Wesley Professional, 2004.

U.S. Pat. No. 5,317,733 describes office automation system for data base management and forms generation.

U.S. Pat. No. 5,448,729 teaches office system with audit history.

U.S. Pat. No. 6,775,827 teaches real-time program audit software.

Here are the definitions and properties for some of the technical terms we use:

### Object-Oriented Paradigm

Object-oriented programming paradigm (abbreviated as OOP) models the real world objects as business “objects”. These business objects then have capability to hold both the data and the methods that apply on the data. For example, an invoice contains the processing date and the amount, and also method applyFuelSurcharge (which adjusts the amount based on the fuel surcharge based on the month of processing) and pay (which initiates a financial debit transaction from the buyer to the seller).

### Objects and Relational Databases

A business data object is usually saved across multiple data tables in a relational database management system. A simple business object such as invoice may be stored in twenty data tables. This apparent inversion may be summarized as: (i) An invoice business object contains all the relevant data for one (and only one) invoice, and (ii) An InvoiceDiscount table, for example, contains the information of only the invoice discounts, but for all invoices.

### Objects and XML

XML is a technology used to provide a representation of business data that is address, database and computer architecture independent. An invoice may be stored in a computers memory at location x, using that computer's architecture, or on the database at records a, b and c. However, none of these representations is convenient in communicating this invoice to a trading partner who is not using the same infrastructure. So, an XML representation (a super specialized String representation) is used to hold the business data, which can then be transmitted to the receiving party. By using a previously shared mapping, the receiving party is able to interpret the same data from the received XML message.

### SUMMARY

The claimed system provides a method and system for auditing business data objects. The system tracks changes to business data of an underlining software system. It tracks changes to a business data object and compares the different versions; hence providing a consistent interpretation of that business data across the system. Using innovative algorithms, the system is able to pinpoint exactly what change was made to a business data object. It has the power to understand complex, hierarchical business data, spanning an unlimited number of tables. Moreover, it is a self-contained system, and it does not add additional complexities to business logic, nor does it disturb the production database.

One of the aspects of the claimed system is its ability to add change tracking of business data to the base system. When any kind of change (states like modification, unchanged, addition, and deletion) occurs in the base system, the base system generates a call to the database. This call is intercepted by the system. It makes an additional call to record the changes in business data object along with the user information, change timestamp, and the changed values. This information is stored in a separate version database. The database records states (versions) of individual data objects, as they are modified, added, and deleted. A version explicitly records each state of an attribute or object as a row in a table along with important transaction information.

According to another aspect of the Claimed System, the integration of the system with the Target System does not need any code changes. When a base system intends to use the claimed system for adding change tracking for its business data objects, it only needs to provide the types of the business data objects. The claimed system then automatically starts tracking changes to the objects of those types, by intercepting their respective save calls.

Another aspect of the Claimed System is that it incorporates a user interface. Hence, allowing an audit reviewer to review the audit history and review the differences either visually or by retrieving XML object containing the differences. The system's interface provides a tabular view of the version information.

Another aspect of the system features data localization and internationalization. The Claimed System fully supports over 20 languages, including English, Spanish, German, French, Dutch, Russian, Portuguese, Swedish, Finnish, Slovene and Danish. It supports both left to right languages, such as English and Spanish, and right to left languages, such as Arabic and Hebrew.

It should be noted that the foregoing general description and the following detailed description are exemplary and explanatory and are intended to provide further explanation of the system as claimed.

### BRIEF DESCRIPTION OF THE DRAWINGS

FIG. 1 illustrates the 4 components of the Claimed System.

FIG. 2 illustrates how the audit history keeper component of the Claimed System intercepts and saves the audit history record to the database.

FIG. 3 illustrates how the audit history retriever part of the Claimed System retrieves the previously saved audit history records from the database.

FIG. 4 illustrates how the audit comparator part of the Claimed System compares two audit history records and computes the difference between the records.

FIG. 5 illustrates how the audit trace is presented to the user.

FIG. 6 illustrates how the difference data is presented to the user.

FIG. 7 illustrates the integration of Target System with the audit system.

FIG. 8 shows an audit difference presenter.

FIG. 9 shows an audit comparator.

FIG. 10 shows an audit history keeper.

FIG. 11 shows an audit history retriever.

FIG. 12 shows another audit comparator, a simplified version of the one in FIG. 9.

### DETAILED DESCRIPTION OF THE PREFERRED EMBODIMENTS

System Architecture

The Claimed System tracks changes to business data of an underlying software system (the “Target System”). It tracks changes to a business data object and compares the different versions.

The Claimed System comprises of four parts: audit history keeper, audit history retriever, audit comparator, and difference presenter. The audit history keeper part of the Claimed System intercepts and saves the audit history record to the version database. The audit history part of the system retrieves the previously saved audit history records from the version database. Audit Comparator compares two audit history records and computes the difference between the records, and the difference presenter presents the differences to the user.

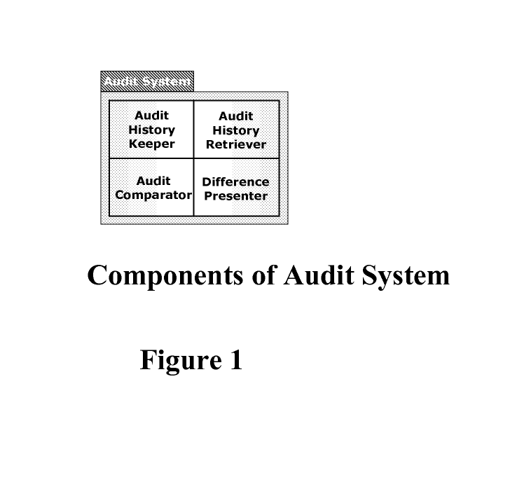

FIG. 1 illustrates the 4 components of the system. All the components of the Claimed System interact with each other to track the changes to the business data, store the data in the version database, and display the data on request. The Audit History Keeper intercepts and saves the audit history record to the audit database. Audit History Retriever retrieves the previously-saved audit history records from the audit database. Audit Comparator compares two audit history records and computes the difference between the records. The Difference Presenter presents the differences to the user.

Audit History Keeper

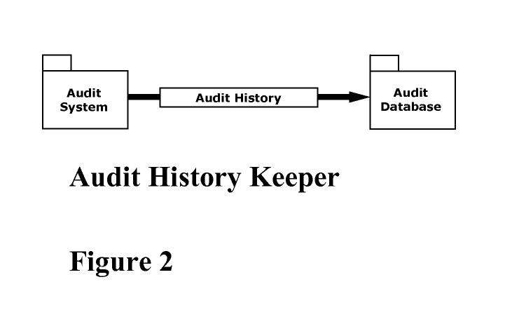

FIG. 2 illustrates how the audit history keeper component intercepts and saves the audit history record to the database. The version (change) information is stored in a separate version database. The database records states (versions) of individual data objects as they are modified, added, and deleted. A version explicitly records each state of an attribute or object as a row in a table along with important transaction information.

The Claimed System tracks changes to business data of the Target software system. When any kind of change (states like modification, unchanged, addition, and deletion) occurs in the base system, the base system generates a call to the database. This call is intercepted by the Claimed System. It makes an additional call to record the changes in the business data object along with the user information, change timestamp, and the changed values.

The Audit History Keeper de-normalizes the business data object so that it can be represented in text, using an XML representation. Following that, it makes an additional call to record the de-normalized XML version of the business data object, along with the user information, and change timestamp, into the Audit Database.

Audit History Retriever

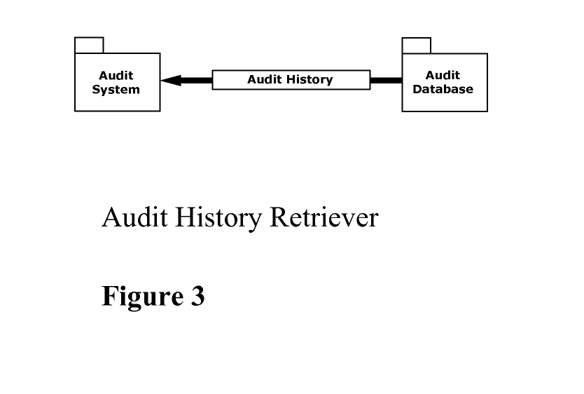

FIG. 3 illustrates how the audit history retriever part of the system retrieves the previously saved audit history records from the database. Upon retrieving the XML version, the audit history retriever recreates the retrieved business data object using the de-normalized XML representation.

Audit Comparator

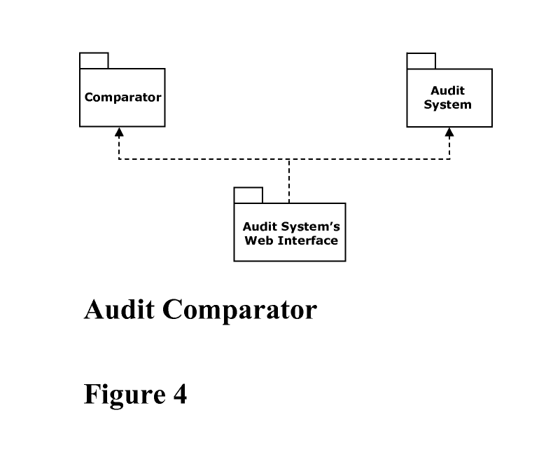

FIG. 4 illustrates how the audit comparator part of the Claimed System compares two audit history records and computes the difference between the records. Using sophisticated algorithms, the system is able to pinpoint exactly what change was made to a business data object. The Claimed System has the power to understand complex, hierarchical business data spanning an unlimited number of tables.

Difference Presenter

The difference presenter component displays the results of the audit system using a web application.

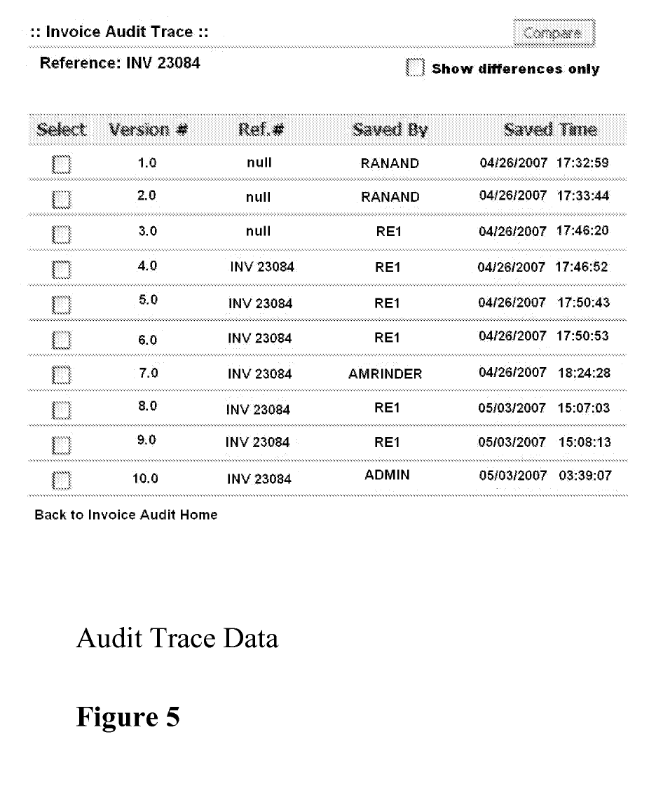

FIG. 5 illustrates how the audit trace is presented to the user. It shows the name of the user who saved each version, as well as the time each version was saved. Checkboxes appearing next to each version can be used to select versions, and to compare the selected versions.

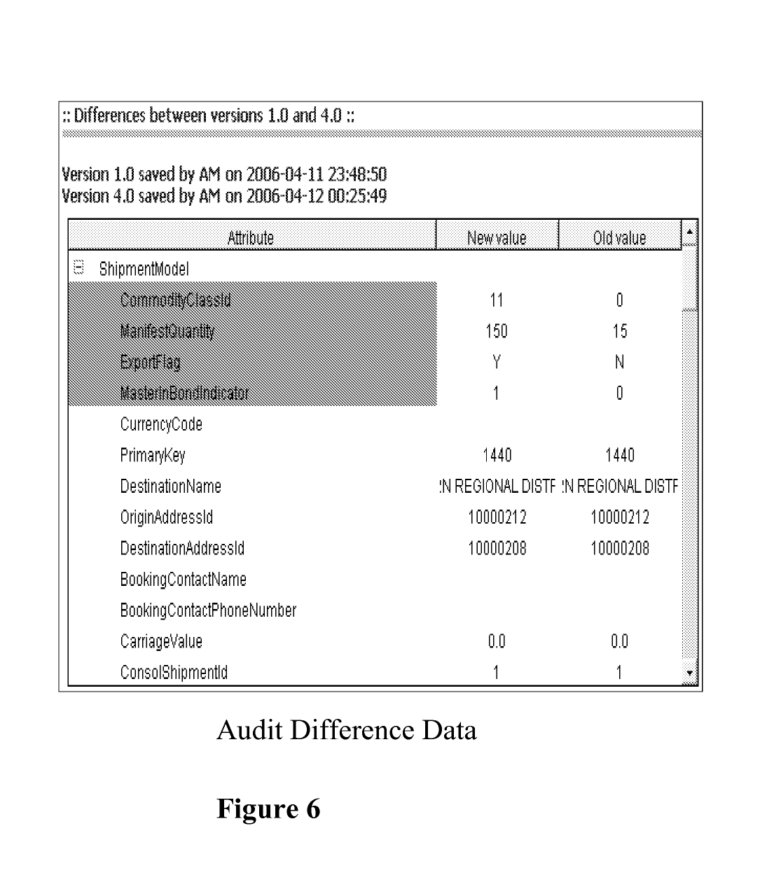

FIG. 6 illustrates how the difference data is presented to the user. The comparison page shows the differences between the selected versions. Since a version usually contains many items, a hierarchical presentation is used to show the changes. Differences are highlighted, and new and old values appear side by side for easy comparison. If a new item was added to the list, it is clearly marked as such. Similarly, if an item was deleted from the list, it is marked as deleted. The system also has the capability to show the difference data as XML. The difference can also be retrieved as an XML object, and the review application can navigate the XML model to identify the differences. A variety of output XML models are supported.

Interaction between different modules

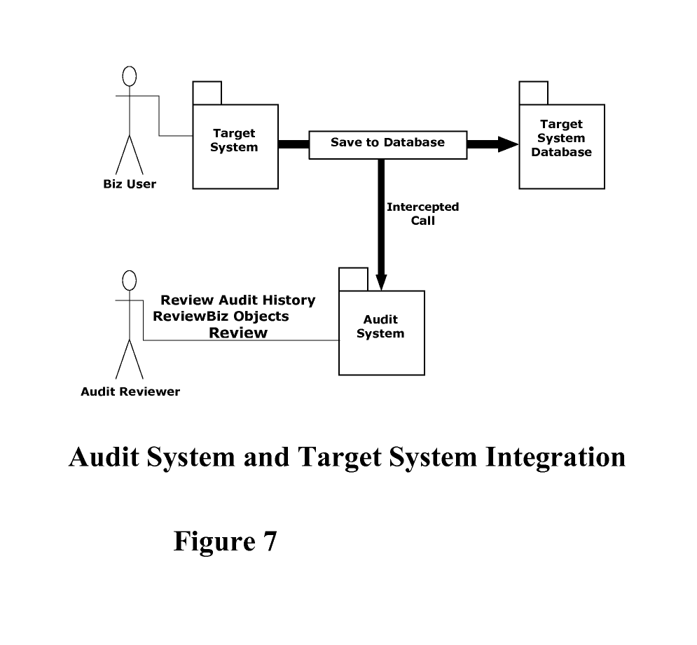

FIG. 7 illustrates the integration of Target System with the components of the Claimed Audit System. The system provides a simple user interface, wherein the user is presented with all the data objects in a table. The table also presents all the “most rapidly changing entities” along with their IDs and number of versions. Using these IDs, the audit reviewer can also search for them, for further reference. All the major changes in entities are also displayed separately, so that the reviewer can have a quick reference to all those data objects which were changed drastically. Finally, the data objects, which the system is tracking, are displayed in the same table, but in a different group, to distinguish them from other items of the table.

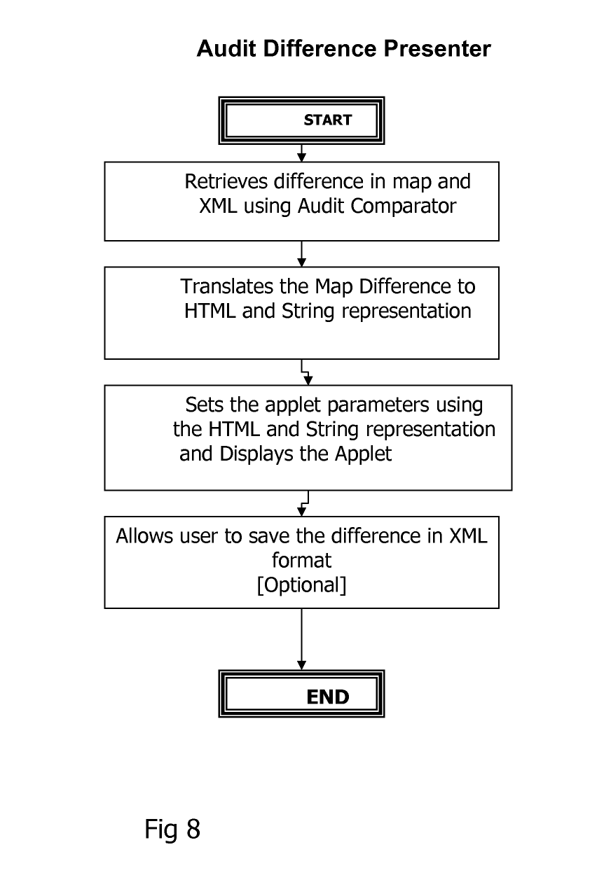

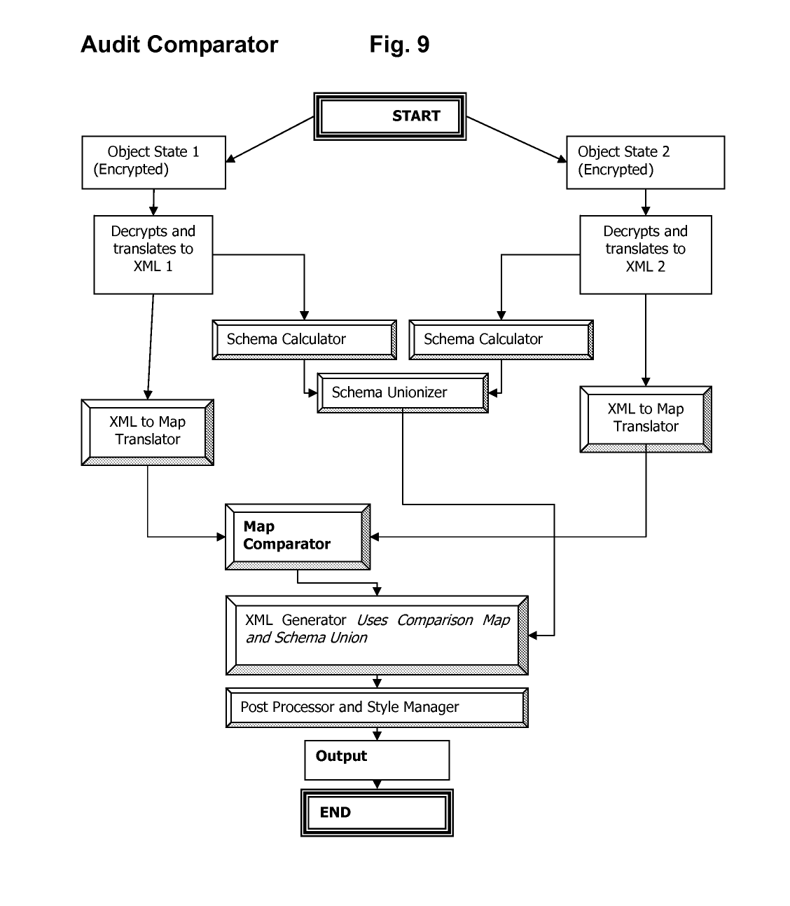

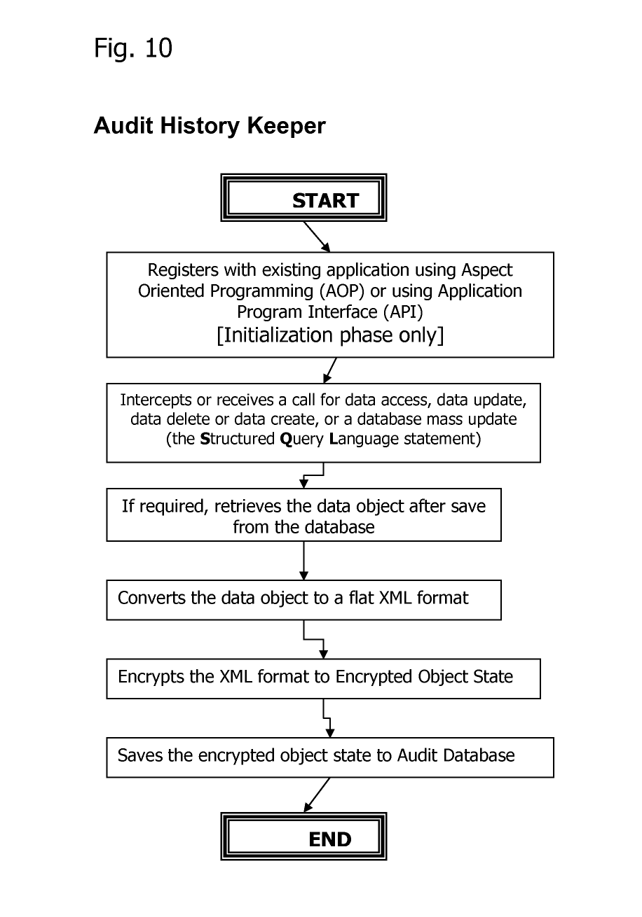

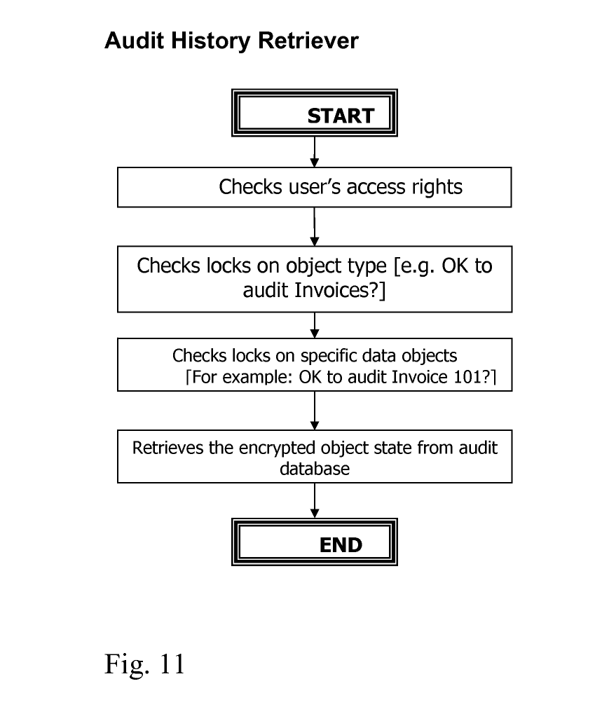

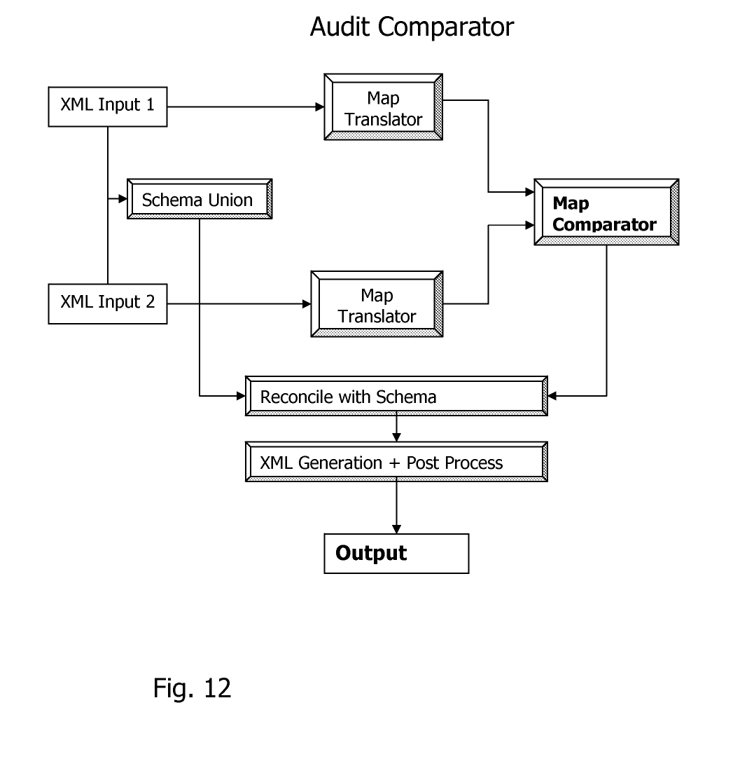

Here are some other embodiments/examples: FIG. 8 shows an audit difference presenter. FIG. 9 shows an audit comparator. FIG. 10 shows an audit history keeper. FIG. 11 shows an audit history retriever. FIG. 12 shows another audit comparator, a simplified version of the one in FIG. 9.

One of the main features of one of the embodiments is the usage of string cipher, instead of the block cipher, to be able to search, without need for complete decryption. This increases the speed of the search.

In FIG. 9, the Schema Unionizer and the step after that are intended to make the output compatible and to put it back in a proper format. In FIG. 9, the post process is done to set the configurable system preference. To have a flexible, accurate, and fast match-up, in FIG. 9, we use the mapping technique, to trim the structured data into a simplified version of the data (translated into a “tree” format, in which the order of the data is not important). For example, considering an invoice with 2 data elements (amount and date), those can be extracted as: 50 dollars and 5 Jul. 2007. Then, they can be compared directly, fast, and efficiently, with the corresponding fields of other business data objects, without using the fields that are not relevant, e.g. “the name of the shipping agent”, and without any specific order of representation of the data.

Generally, comparison between 2 or more objects or data (or files) can be accomplished by many methods. For example, one can use (brute-force) bit-by-bit comparison. Or, one can compare only specific fields. Or, one can compare the headers only. Or, one can compare the sizes. Or, one can compare the compressed versions (e.g. lossy compression versions, for faster/fewer comparisons). Or, one can compare the signatures or hash functions. Or, one can compare the pattern recognized in the data. Or, one can compare exactly. Or, one can compare approximately, for faster results. Or, one can compare the down-sampled versions. One can compare the quantized versions. Or, one can compare the associated tags. Or, one can compare the associated summaries or descriptions. Or, one can compare randomly, for some data only, to increase the speed. Or, one can compare the objects in a domain or with respect to a coordinate that signifies or amplifies the differences, as the highlighted features, such as with respect to a normalized basis functions or eigenvectors, in an N-dimensional feature space, where the basis functions are typically (or chosen as) orthogonal or orthonormal. The features can be hierarchical. That is features within another feature (as sub-features).

This can be applied to any documents, and for any purpose, such as legal documents (e.g. for courts), financial documents, educational documents, and organizational documents. The structure of comparisons can be hierarchical, in different stages. It can be step-by-step. It can be parallel. It can be in series. It can be in combination of the above. It can also be selective, only based on one or more features. It can also be adaptive comparison, in which parameters are changing, based on the environment and/or context. The criteria can be changed, as well, as adaptive or dynamic parameter.

The difference presenter can display or present all the differences. Or, it can highlight the important or major differences, only. Or, it can show the smaller version of the figures or drawings, if applicable, for images. Or, it can show at a lower resolution. It can show as wavelet components of a figure, if applicable, for images. Or, it can show that in an encrypted form. Or, it can show that in a compressed form. Or, it can show that in a lossy compressed form.

The system can use a relational database, to find the differences faster, to put the information in a specific format or order, to be able to access those faster, or to be able to find a pattern faster. For 2 sets of data, partially referring to the same point(s) or common characteristics in the table, the comparisons can be done much faster, with fewer calculations and fewer comparisons.

Audit history can be saved as a whole. Or, it can be saved as the delta/differences. Or, it can have different version numbers, associated with time, e.g. with a time-stamp. Or, it can be indexed, for faster access or search.

Any variations of the teachings above are also meant to be covered and protected by the current patent application.

1. A system for auditing, tracking, or inspection of data, objects, or their corresponding modifications, said system comprising:
an audit history keeper subsystem,
an audit history retriever subsystem,
an audit comparator subsystem, and
a difference presenter subsystem,
wherein said audit history keeper subsystem intercepts said data or said objects,
wherein said audit history keeper subsystem saves an audit history record in a database,
wherein said audit history retriever subsystem retrieves a previously saved audit history record from said database,
wherein said audit comparator subsystem compares two or more audit history records,
wherein said audit comparator subsystem computes the difference between said two or more audit history records, and
wherein said difference presenter subsystem presents or displays an audit trace, tracking result, audit result, or a difference data.

2. A system as recited in claim 1, wherein said system is added to, or works with, an existing target software.

3. A system as recited in claim 1, wherein said system performs version comparison, object comparison, or chain of objects comparison.

4. A system as recited in claim 1, wherein said system performs correction, update, or modification on said data or said objects.

5. A system as recited in claim 1, wherein said system searches history or different versions.

6. A system as recited in claim 1, wherein said system uses XML representation.

7. A system as recited in claim 1, wherein said system presents a summary of an audit tracking functionality through a web application.

8. A system as recited in claim 1, wherein said system presents a history of a business data object through a web application.

9. A system as recited in claim 1, wherein said system presents differences between two versions of a business data object through a web application.

10. A system as recited in claim 1, wherein said system merges the differences between business data objects.

11. A system as recited in claim 1, wherein said data or said objects is one or more of the following: an invoice, security, stock, bond, product, order, shipment, payment, account, inventory, bill, supply, check, voucher, coupon, or financial document.

12. A system as recited in claim 1, wherein said system is configured to work with a target software, without necessitating modifications to said target software.

13. A system as recited in claim 1, wherein said system lets a user search for a particular business data object, using current or historical information.

14. A system as recited in claim 1, wherein said system has a localized representation or script.

15. A system as recited in claim 1, wherein said system prioritizes the attributes of a business data object.

16. A system as recited in claim 1, wherein said system works without a user interface.

17. A system as recited in claim 1, wherein said system displays the business data objects which have been subject to major changes.

18. A system as recited in claim 1, wherein said system displays a history of a data object.

19. A system as recited in claim 1, wherein said system selects any two versions from a history of the business data object for comparison.

20. A system as recited in claim 1, wherein said system gives the option to view only the differences between data fields, or the option to view everything.

21. A system as recited in claim 1, wherein said system presents the differences between data fields in an expandable tree view format.

22. A system as recited in claim 1, wherein said system presents the differences between data fields using different colors or symbols.
